(19) United States
(12) Patent Application Publication
(10) Pub. No.: US 2024/0310796 A1
(43) Pub. Date: Sep. 19, 2024

(54) METHOD FOR OPERATING A CABLE PROCESSING DEVICE, CABLE PROCESSING DEVICE, EVALUATION AND/OR CONTROL DEVICE FOR A CABLE PROCESSING DEVICE AND MACHINE-READABLE PROGRAM CODE

(71) Applicant: MD Elektronik GmbH, Waldkraiburg (DE)

(72) Inventors: Josef OHNI, Kraiburg am Inn (DE); Martina OSSNER, Geisenhausen (DE); Stefan GRANDL, Polling (DE); Peter HOFINGER, Vilsbiburg (DE)

(21) Appl. No.: 18/583,658

(22) Filed: Feb. 21, 2024

(30) Foreign Application Priority Data
Mar. 13, 2023 (EP) 23161530.3

(51) Int. Cl. G05B 13/02; G06V 10/25; G06V 10/764; G06V 10/82

(52) U.S. Cl. CPC G05B 13/027; G06V 10/25; G06V 10/764; G06V 10/82; G06V 2201/06

(57) ABSTRACT

Embodiments herein relate to operating a cable processing device by processing at least one cable section by a cable processing unit from an initial configuration to an end configuration, capturing at least one image of the at least one end configuration, applying a trained neural network to the at least one captured image to determine at least one region of interest from the at least one captured image in a first step, and the same neural network being designed to, in a second step, perform a classification of the at least one determined region of interest with regard to the presence of at least one learned error pattern of the at least one end configuration and determining a result associated with the classification. Moreover, a control signal is generated depending on the determined region of interest or depending on the result of the classification.

### TECHNICAL FIELD

The invention relates to a method for operating a cable processing device, a cable processing device, a control device for a cable processing device and a machine-readable program code. The present invention is mainly described in connection with data cables. It is understood that the present invention can be used for any type of cable.

### STATE OF THE ART

In the manufacture of data cables, the cables are usually processed in an automated processing system and, for example, assembled, i.e. cut to the appropriate length, and provided with corresponding electrical contacts and/or connectors. A single automated processing system comprises several stations, which are also referred to as cable processing units in the context of this application. In each cable processing unit, a defined processing step is carried out for a cable.

In order to enable error-free processing of such cables in large quantities, the cables must be checked in the respective processing unit for correct implementation of the individual processing steps. In particular, it is necessary within a particular processing system to check before individual cable processing units the cables fed to the respective cable processing unit or the cables leaving this cable processing unit to determine whether the cables meet specified requirements in order to be processed further. The cables generally have an initial configuration. This is the state in which a cable or a cable section to be processed is fed to a cable processing unit. The cable or cable section is then subjected to a processing step and transferred from the initial configuration to an end configuration. This is the state in which a cable or cable section leaves the cable processing unit processing the cable or cable section.

For this purpose, it is known to detect and evaluate cables or cable sections by means of image recognition.

Image processing programs that use classic rule-based object recognition are often inflexible and complex and sometimes very difficult to implement reliably.

For this reason, AI-based models are increasingly being used to monitor production. For example, a cable processing station is known from publication EP 3 855 359 A1, which has an imaging sensor device by means of which a cable end can be detected. A first and a second cable-specific image parameter are recognized by means of an image processing system. On the basis of the detected first and second cable-specific image parameters, a control-specific parameter is created by means of the image processing system, which is transmitted to a control device for controlling a tool. Such a method is intended to enable rapid adjustment of the cable processing process for recognized cable types.

Further, US 2021/0049754 A1 (D2) discloses a method of operating a cable processing device comprising merging an element with a cable to form a connection of the cable to the element, capturing an upper image and a lower image by an image capturing device from the connection of the cable to the element, analyzing the upper image and the lower image to identify a defect, and outputting a detected defect. For this purpose, it is known from D2 to use an AI program for object recognition. The AI-based object recognition can also be designed to perform defect detection.

It has been shown that such methods also require further improvement, as the reliability and accuracy are often not sufficiently high for the problems of production.

### DESCRIPTION OF THE INVENTION

It is the task of the invention to provide a solution with which a robust possibility is created to reliably and quickly determine an end configuration of a cable section and thus to further improve the process of cable processing.

The task is solved by the objects of the independent claims. Advantageous further embodiments of the invention are given in the dependent claims, the description, and the accompanying figures. In particular, the independent claims of one category of claims can also be further developed analogously to the dependent claims of another category of claims. Further embodiments and further developments of the invention that result from the subclaims and from the description with reference to the figures.

The present invention relates in particular to a method for operating a cable processing device, comprising processing at least one cable section, in particular a cable end, by means of a cable processing unit from an initial configuration to an end configuration. At least one image of the at least one end configuration is recorded by means of an image recording device. A trained neural network is applied to the at least one captured image, wherein the trained neural network is designed to determine, in a first step, at least one region of interest of the at least one end configuration from the at least one captured image and the same neural network is designed to determine, in a second step, a classification of the at least one determined region of interest with regard to the presence of at least one learned error pattern of the at least one end configuration and to determine a result associated with the classification. A control signal is then generated, depending on the at least one determined area of interest and depending on the determined result of the classification of the at least one end configuration, and output.

By means of the present method, a robust and fast solution is provided by means of which learned end configurations of a cable section can be recognized and/or classified. In particular, the determination of the at least one area of interest and the classification can take place in real time, i.e. without delay in production.

It has been shown that the use of the same neural network for the determination of the at least one area of interest and the subsequent classification of the determined area of interest and the associated determination of the result has proven to be particularly robust against variable environmental influences and variances, in particular during image acquisition, and thus has a high level of reliability.

Furthermore, a neural network trained in this way can be built up with fewer layers, which on the one hand means that the response times for any control of a process of the cable processing device are shorter and thus a control intervention can take place more quickly. Furthermore, the effort required to train the network is reduced. Advantageously, the trained neural network is formed as a deep neural network, also referred to as a deep neural network, in particular as a convolutional deep neural network, also referred to as a deep convolutional neural network.

The present invention therefore provides for the use of a specially trained artificial neural network and the detection of error patterns with the aid of the appropriately trained neural network.

The neural network is trained by means of corresponding training data sets and trained in a manner specified in the claims. As part of such training, the trainable neural network can be presented with corresponding training data, which has already been divided in advance into positive training examples, e.g. end configurations comprising at least one error-free area of interest, and negative training examples, e.g. end configurations comprising at least one error-prone area of interest. Furthermore, the training data also includes a corresponding result of the classification. Such a training data set can be created manually, for example, or from the results of a conventional image processing system in combination with corresponding manufacturing information. The images are easy to obtain as cable production can be routinely monitored and the data may be stored for some time. Furthermore, even today, cable production is monitored for defects and defect types primarily by personnel.

A possible embodiment for the creation of a training data set and the training of the neural network is described below. It is understood that the described creation and training can also be performed independently of a cable processing device. The present disclosure therefore explicitly discloses such a creation and a corresponding training as separate objects.

For the training of the neural network, a corresponding set of training images is generated. The images show at least one region of interest of an end configuration and an associated classification result, e.g. “ok” or “not ok”. A corresponding qualification of the training image data sets is carried out according to the area of interest shown and the classification result, whereby not only the criterion of faulty vs. faultless can be provided, but also, for example, the specific error pattern can be annotated for the respective image.

The acquisition of corresponding images and their qualification can take place during normal production operation of the cable processing device, so that a plurality of images with different size, viewing direction, rotation, contrast, lighting, occlusion, etc. can be generated and the area of interest, which is usually determined offline, and its classification or the classification result can be supplemented. This qualification of the images can be carried out manually or at least partially by a conventional image processing system, whereby manual reworking is possible. The pre-qualified training images are then pre-processed accordingly for training.

For example, the size of the training images can be adjusted to a predefined size. In particular, the number of pixels of the training images can be adapted to the number of inputs of an input layer of the neural network. The pre-processing of the training images can also include the normalization of the images. For example, the images can be available as RGB images as they are transmitted by an image recording device. This means that preparation and pre-processing of the images is preferably avoided so that the trained neural network can handle corresponding raw data, which increases the subsequent speed of image evaluation.

In order to improve the results of the neural network and make them more robust, the training images can be subjected to random image manipulations. Such image manipulations may, for example, involve rotation, zooming in, zooming out and/or distortion. It is understood that corresponding orders of magnitude can be specified for the respective image manipulation.

For example, a maximum magnification or reduction can be specified as a percentage for zooming in or out, e.g. 110% or 90%. For rotation, for example, a maximum or minimum rotation angle, e.g. +/−10°, 20° or 30°, can be specified. Corresponding limit values can also be specified for distortion. It is understood that different algorithms can be used for image distortion, which can have different parameters.

The image manipulations are used to provide the training data with greater variability. The end configuration or the majority of end configurations will therefore be present at different locations and in different sizes in the image. This prevents, for example, the neural network from learning to identify the specified feature only in a small section of an image and incorrectly concluding that the feature is not present, even though it is only outside the section, for example.

After pre-processing the training images, the neural network is trained with some of the training images obtained in this way. The remaining training images can be used to check the learning success by feeding them to the trained neural network and comparing its output with the known or expected output for the respective training image. This part of the training images can therefore also be referred to as test data.

Once the training has been completed, the quality of the training can be checked, as already mentioned above, by means of a qualification of the test data by the trained neural network. If the results achieve the desired quality, the training can be ended. If the results have not yet reached the desired quality, or if the neural network is to be trained further, the training can be continued with corresponding training data or carried out again with modified parameters.

The at least one end configuration is recorded using at least one image from an image recording device. Preferably, the at least one image is captured digitally, for example by means of a CCD camera for generating images in a spectral range visible to the human eye. The image recording device is positioned and aligned in such a way that the at least one end configuration is typically arranged in the recording area of the image recording device. If necessary, a plurality of images or a plurality of image recording devices can also be provided, which reliably record the at least one end configuration. It may be more advantageous to enlarge the recording area and adapt the resolution of the image recording device accordingly.

It is understood that the training can be carried out differently depending on the type of neural network used. In principle, for each type of training, the weights of the neural network are adjusted for each training run so that the error of the output of the neural network is minimized compared to the known result from the training data set. This is usually achieved by so-called back-propagation, error feedback or back-propagation.

A so-called number of epochs and a termination criterion can also be specified for the training. The number of epochs specifies the number of training runs. A predefined number of training data, e.g. all training data or only a selection of training data, can be used for each training run. The termination criterion specifies how far the result of the trainable neural network may deviate from the ideal result in order for the training to be considered successfully completed and thus the neural network to be sufficiently well trained.

In particular, the neural network can be designed as a deep convolutional neural network, hereinafter also abbreviated as dCNN. CNNs and dCNNs deliver very good results, especially for the classification of objects in image data. It goes without saying that other suitable neural networks from the field of machine learning are also possible.

Such a dCNN can have an input layer as well as a plurality of hidden layers and an output layer. The hidden layers can have at least partially identical or repeating layers.

The input layer may have an input for each pixel of the captured images. It is understood that the images can be transmitted to the input layer, for example, as an array or vector with the corresponding number of elements. Furthermore, the size of the captured images may be the same for all images. For example, the images can have 1024*1024 pixels, which represent an image area of 25 cm by 25 cm for corresponding end configurations. It is understood that these specifications are merely exemplary and that other image parameters can be used.

A schematic layer structure of the neural network is explained below. The first layer of the trained neural network is used to feed the image data to be analyzed to the input layer of the neural network.

### Layer 1: Input Tensor

The hidden layers can perform a kind of preparation of the input data for further processing by the neural network and then process it further in a plurality of identical blocks. These layers can be, for example, layers for filling with zeros, so-called zero padding layers, layers for convolution, layers for normalization, and layers for activation, in particular by means of a so-called ReLU function, also known as a rectified linear unit.

An exemplary layer structure of such layers for processing the data can be as follows:
Layer 2: Transpose (transposition of the input tensor for further processing)
Layer 3: Sub (subtraction operation for transposed tensor)
Layer 4: Convolution (convolution operation)
Layer 5: Activation (activation function—ReLU)
Layer 6: MaxPooling (selection of maximum values)

This can be followed by another exemplary block for further analysis of the processed data:
Layer 7: Convolution (convolution operation)
Layer 8: Activation (activation function—ReLU)
Layer 9: Convolution (convolution operation)
Layer 10: Activation (activation function—ReLU)
Layer 11: Convolution (convolution operation)
Layer 12: Addition (addition operator)

Data from layer 6 can also be processed in parallel with just one convolution operation, whereby this is then added to the result of layer 11 in layer 12. It is understood that different layer arrangements are possible and the above structure is only shown as an example.

These layers can also be followed by blocks, each of which can have an identical structure to the block shown above.

The output layer or output layer of the neural network can then be used to output corresponding information on the area of interest and the classification, e.g. number of areas of interest determined, type of areas of interest determined (e.g. crimp sleeve, grommet, internal contact, etc.), fault status, such as faulty or fault-free, a corresponding probability for the presence of the fault status determined and identification of a specific error pattern.

As a result, a neural network with, for example, 274 layers can be provided, which is trained by means of corresponding training data to carry out the image evaluation in accordance with the invention.

The end configurations can be designed in different ways. Typically, the end configuration of a cable section is characterized by the preceding processing step, which takes place between the initial configuration and the end configuration. In particular, the cable section can be a cable end.

However, it is possible that the entire cable is also considered to be the end configuration, especially if different parts of the cable are processed in different cable processing units and different cable sections of the same cable are captured with different image recording devices. The end configuration of the cable is always changed when a cable section of this cable is further processed.

In addition to the cable section, the end configuration can include at least one further element, for example from the group crimp sleeve, contact pin, plug, inner conductor, outer conductor, braided shield, connecting tube, cable, cable sheath, insulator, grommet, laser marking of the cable as an alphanumeric character string, coupling, holder for grommets, cable holder, separator, housing, dirt flap, ferrule for optical conductors, label, silicone insulating tube, etc., which are processed together with the cable section in the processing step of the processing unit. The end configuration can also include only elements of the cable, e.g. a stripped end with an adjacent non-stripped part as part of a partial stripping processing step. The end configuration can also only include components arranged on the cable, but not the cable itself, e.g. the combination of housing and housing dirt flap.

Since at least one cable section, in particular a cable end, is processed in the cable processing unit, and an end configuration is always assigned to the processed cable section, a corresponding plurality of end configurations can also be present when a plurality of cable sections is processed simultaneously by the cable processing unit. In this sense, the presence of at least one end configuration follows from the presence of at least one cable section.

Usually, the plurality of end configurations of the cable sections which are processed simultaneously by the same cable processing unit are similar; for example, all cable sections, e.g. cable ends, are each fitted with a crimp sleeve and crimped. This means that the end configuration, in this case the crimp sleeve crimped onto the cable section, generally only differs for the majority of cable sections in terms of whether or not there is an error pattern for the respective end configuration of the respective cable section, e.g. whether or not it was crimped incorrectly.

The area of interest of the end configuration of the at least one cable section is determined by the trained neural network to be the image area that was taught as the area of interest according to the training data, provided that it is present in the captured image. The area of interest of the end configuration can be selected in particular from the group: crimp sleeve, contact pin, connector, inner conductor, outer conductor, braided shield, connecting tube, cable, cable sheath, insulator, grommet, laser marking of the cable as an alphanumeric character string, coupling, holder for grommets, cable holder, separator, housing, dirt flap, ferrule for optical conductors, label, silicone insulating tube, etc. If there is a plurality of end configurations, since a plurality of cable sections are processed by means of the cable processing unit, a plurality of areas of interest is determined accordingly, whereby only one area of interest or a plurality of areas of interest can be determined for each end configuration.

It is often sufficient to determine only one area of interest per end configuration and classify it using the trained neural network. In this case, the determined area of interest is classified in isolation. However, several areas of interest can also be determined for a particular end configuration. This is of particular interest for different components, which may include the cable section, and the respective end configurations.

As a result of the classification, it can, for example, be determined in a first step whether an end configuration is faulty or fault-free, e.g. the result can be “OK” or “good” for an end configuration that was determined to be fault-free or “not OK” or “not good” for an end configuration that was determined to be faulty. In particular, the result can be communicated by means of color codes, e.g. green marking of an area of interest as error-free and red marking of an area of interest as faulty. In a second step, e.g. at the request of a user or a control device, the specific error pattern can be identified from a plurality of possible error patterns for faulty end configurations. The complete information of the output vector of the neural network can also always be made available by default, in particular for a control device.

In a further embodiment of the method, the image capture device is used to capture an image showing two to 100 end configurations, wherein the trained neural network is designed to determine at least one region of interest for each of the two to 100 end configurations, in particular for each of the two to 100 end configurations, and to determine at least one result associated with the classification of the regions of interest, and the trained neural network is applied to the captured image, when a control signal is generated and output for the two to 100 captured end configurations, in particular for each of the two to 100 captured end configurations, on the basis of the determined at least one region of interest and/or the result assigned to the classification for the respective end configuration.

By means of such a design, it is possible to significantly increase the throughput of a cable processing unit through parallelized processing without running the risk that efficient and reliable error pattern control by a human supervisor is no longer possible. Rather, the use of an appropriately designed neural network enables reliable error pattern control in real time for a plurality of cable sections or end configurations processed in parallel, thereby significantly improving the production process. By generating and outputting a corresponding control signal, the corresponding cable or cable section can be further processed depending on the classification result, e.g. specifically separated from further parallelized processing.

Preferably, the captured image shows at least 10 to 100, in particular 20 to 100, in particular 30 to 100, in particular 40 to 100 end configurations. For each end configuration shown, at least one region of interest is determined by means of the neural network trained for this purpose.

In a further embodiment of the aforementioned embodiment, the trained neural network is designed to determine at least one region of interest with an associated probability value for a maximum number of end configurations, wherein the neural network is further designed to determine a probability value below a predetermined threshold value for a difference between the number of detected end configurations and the maximum number, wherein the neural network is further designed to ensure that regions of interest with a probability value below the predetermined threshold value are not classified. This allows the neural network to be used flexibly for a variable number of cables processed in parallel. Furthermore, no classification is performed for areas of interest whose probability value does not exceed a threshold value because they are not present in the captured image, which increases the speed of the neural network and conserves computing resources.

In a further embodiment of the method, the trained neural network is designed to determine, for at least one end configuration, at least one first region of interest and, for the same end configuration, at least one second region of interest, which differs spatially from the first region of interest, from the at least one captured image, and the trained neural network is furthermore designed to additionally taking into account a relative parameter of the at least first region of interest and of the second region of interest for the classification and determining a result associated with the classification, and wherein the trained neural network is applied to the at least one image, wherein a control signal for the at least one end configuration is generated and output on the basis of the result of the classification taking into account the relative position.

A plurality of different regions of interest, in particular two, three or four regions of interest, can thus be determined for an end configuration. Furthermore, a plurality of different areas of interest can be determined for a plurality of end configurations, in particular 2 to 100. In addition, a relational relationship between different cable sections of the same cable, in this case the end configuration, in addition to the end configurations of the cable sections, across different cable processing units can be taken into account.

In this embodiment, the classification is no longer carried out only in isolation for the determined area of interest, but a relative parameter of the at least two determined areas of interest of the same end configuration is also taken into account for the classification of the end configuration. For example, the relative position can be provided as a relative parameter. Relative position is to be understood broadly in this context; for example, a relative orientation, a relative displacement, or relative rotation or even a distance between the at least first and at least second region of interest can be included.

By including the relative position of the at least first and the at least second region of interest in the classification, information can be obtained as to whether various components detected by an end configuration are arranged in relation to each other without errors. For example, a crimp sleeve can be recognized as the first area of interest and a stripped cable end can be recognized as the second area of interest, whereby the distance between the first area of interest and the second area is then evaluated. This can be used to determine whether the crimp sleeve is positioned correctly on the stripped cable end, in particular whether the crimp sleeve covers too much of the stripped cable end or is positioned too far away from the stripped area. Furthermore, the longitudinal direction of the crimp sleeve and the longitudinal direction of the stripped cable end can also be taken into account in order to determine a skew of the crimp sleeve relative to the cable end.

Furthermore, a functional affiliation of the first and second areas of interest to a specific component class can be taken into account as a relative parameter. For example, it can be determined whether a grommet, the first area of interest, is arranged at one end of an almost finished cable and whether a crimp sleeve is provided at the other end, the second area of interest, which is still being processed.

In this case, the neural network is trained in such a way that a determined region of interest is associated with a specific component, e.g. that a first region of interest is a grommet and a second region of interest is a crimp sleeve, whereby a comparison of the number of grommets and crimp sleeves for the same cable is then taken into account as a relative parameter for the classification. Furthermore, the neural network can be designed to determine whether for each determined area of interest in the form of a crimp sleeve there is exactly one area of interest in the form of a grommet along the cable. It should be understood that this is merely exemplary and that the classification, which takes into account a relative parameter, can also be provided for other components.

This embodiment makes it possible to classify complex end configurations assembled using different components in real time and thus to handle the manufacturing process reliably. In particular, this form of classification can be used for an image comprising 2 to 100 end configurations, so that complex manufacturing processes can be monitored for errors at high throughput.

In a further embodiment, the image of the at least one end configuration is captured by means of a digital image capture device in such a way that at least one region of interest is represented by at least 20 pixels, preferably more than 50 pixels. It has been shown that the trained neural network provides particularly reliable results if an area of interest is represented by at least 20 pixels, preferably more than 50 pixels, in the captured image. This can be achieved, for example, if the image capture device has a resolution of 1 megapixel or more and the capture area in which the plurality of end configurations is arranged is 25 cm by 25 cm.

In a further embodiment, the trained neural network is designed to determine the complete image capture of an end configuration, wherein the trained neural network is applied to the captured image, wherein in the case of a determined incomplete capture of at least one end configuration, a control signal is generated and output, which causes the notification of an image capture error. This is generally not an error in the manufacturing process, but an error in the image capture process. This does not mean that processed cable sections that have not been captured correctly are faulty. It simply means that an area of interest and/or a classification cannot be made with the captured image due to the incomplete capture of a certain end configuration. In the event of an error, it is therefore necessary to check whether the image capture device needs to be readjusted or whether an end configuration has not been fully captured for other reasons, e.g. defective cable routing. Preferably, the trained neural network for determining the completeness of an end configuration is the same neural network that is also trained to perform the at least one area of interest and the classification of the at least one area of interest.

In a further embodiment, the control signal is used to cause a graphical display of the at least one determined region of interest in an image showing the at least one end configuration, in particular the image to which the trained neural network was applied, in particular as a colored outline of the at least one determined region of interest, on an image output device. By outputting a graphical display on an image output device, the personnel can see whether and which area or areas in the captured image have been identified as the area or areas of interest. This allows a plausibility check to be carried out. Preferably, a colored frame or a colored border can be used to make a determined area of interest or determined areas of interest on the image showing the end configuration quickly detectable for the personnel.

Advantageously, the frame can use the frame color to identify the type of determined area of interest, e.g. a specific cable section or a specific component.

According to a further embodiment, the control signal is used to initiate a graphical display of the result of the classification for the at least one end configuration in an image showing the at least one end configuration, in particular the image on which the classification is based, on an image output device. The graphical display of the result of the classification can be reproduced in particular as color indexing and/or as a text module, e.g. “OK” or “good” or “not OK” or “not good”.

In particular, it can be advantageous if the frame uses the color to indicate for which at least one determined area of interest there is a classification result that corresponds to an error pattern and for which at least one determined area of interest there is a classification result that corresponds to an error-free state.

This graphical output also allows personnel to quickly and easily visually detect which end configuration or which areas of interest have been classified as faulty or fault-free.

In a further embodiment, the graphical display shows an error pattern assigned to the result of the classification in the form of an error pattern designation. This not only allows the personnel to determine whether an end configuration is faulty or fault-free in the sense of “OK” or “not OK”, but the personnel are also informed about the type of error pattern.

In a further embodiment of the invention, the control signal is used to influence the operation of the cable processing unit in such a way that the end configuration of a cable section to be processed subsequently is brought closer to a desired, in particular error-free, end configuration by means of the same cable processing unit. In this case, the result of the classification is used for a control intervention of the cable processing unit in order to avoid a corresponding error pattern for subsequently produced end configurations by means of the cable processing unit as far as possible.

In this context, the determined area of interest and the result of the classification can be used as input data for a trained neural network for controlling the cable processing unit. This trained neural control network is preferably designed to generate and output a control signal for influencing at least one control variable of the cable processing unit on the basis of at least one determined area of interest and an associated classification result, which reduces the probability of the presence of an incorrect end configuration for a next cable section to be processed after it has been processed.

In a further embodiment, the control signal is used to influence a downstream cable processing of at least one classified end configuration of a downstream cable processing unit that is process-wise provided downstream of the cable processing unit depending on the result of the classification of this end configuration. This allows corrective processing of faulty end configurations by subsequent processes, as far as possible, in order to avoid production rejects.

In this context, the determined area of interest and the result of the classification can be used as input data for a trained neural network to control a subsequent process, i.e. a processing step that follows the processing step in the context of which the end configuration was determined to be faulty. This trained neural control network is preferably designed to generate and output a control signal for influencing at least one control variable of a downstream cable processing unit on the basis of at least one determined region of interest and an associated classification result. As a result, an incorrect end configuration can be processed individually and corrected so that production waste is avoided.

In a further embodiment, the control signal is used to initiate a rejection of a cable section with an end configuration with an error pattern from a production process still to be run through, whereby rejection takes place if the result of the classification for this end configuration corresponds to a predetermined error pattern with a probability above a predetermined probability threshold value and cannot be corrected by means of a downstream cable processing unit. This alternative is advantageous if an error pattern of an end configuration cannot be corrected by subsequent processes. This may be the case for certain predefined error patterns with a sufficiently high degree of certainty that have been identified. These error patterns that cannot be corrected with a high degree of certainty may depend on the respective production setup and may also depend on the arrangement of the cable processing units in the material flow direction. If the error pattern of the end configuration cannot be corrected, it is advantageous not to process the faulty end configuration any further and to eject it from the production process or separate it out as soon as possible.

The invention also relates to a cable processing device comprising: a cable processing unit, which is designed to pick up at least one cable section, in particular a cable end, and to process it in such a way that the at least one cable section is transferred from an initial configuration to an end configuration, an image recording device, arranged and designed to record at least one image of the at least one end configuration, an evaluation device and a control device for controlling and/or regulating the cable processing device, wherein the evaluation unit is operatively connected to the image recording device and the control device, and wherein machine-readable program code can be loaded into the evaluation device and/or into the control device, which program code, when executed, causes the method according to one of the preceding claims to be carried out. By means of such a cable processing device, in particular an automated quality inspection of the cable manufacturing process can be carried out.

The cable processing device thus comprises in particular a trained neural network for evaluating the at least one recorded image of the at least one end configuration, wherein the neural network is trained in such a way that in a first step at least one region of interest of the at least one end configuration is determined from the image and in a second step a classification of the at least one determined region of interest is carried out with regard to the presence of an error pattern of the end configuration, the evaluation device being designed to output a control signal as a function of the determined region of interest and/or as a function of a determined result of the classification of the end configuration.

The invention also relates to a machine-readable program code for an evaluation device and/or control device, which comprises control commands which, when executed by means of the evaluation device and/or the control device, cause the method according to one of the method claims to be carried out.

The invention also relates to a control and/or evaluation device with machine-readable program code which comprises control instructions which, when executed by means of the evaluation device and/or control device, cause the method according to one of the method claims to be carried out.

Advantageously, the evaluation device, in particular in the form of a machine-readable program code, accesses a trained neural network which is designed to determine, in a first step, at least one region of interest of the at least one end configuration from the at least one captured image and, in a second step, to perform a classification of the at least one determined region of interest with regard to the presence of a learned error pattern of the at least one end configuration and to determine a result associated with the classification, and to generate and output a control signal as a function of the at least one determined region of interest and/or as a function of the determined result of the classification of the at least one end configuration. The evaluation device, in particular the program code implementing the trained neural network, can be accessed by accessing a local memory; alternatively, it can also be accessed by accessing a cloud on which the corresponding neural network is implemented.

Advantageously, the trained neural network, which is accessed by the evaluation device, is also designed to determine at least one area of interest for two to 100 end configurations, in particular for each of the two to 100 end configurations, and to determine a result associated with the classification of the areas of interest, wherein a control signal for the two to 100 detected end configurations, in particular for each of the two to 100 detected end configurations, can be generated and output on the basis of the determined at least one region of interest and/or the result assigned to the classification for the respective end configuration.

Advantageously, the trained neural network, which is accessed by the evaluation device, is furthermore designed to determine at least one first region of interest for at least one end configuration and at least one second region of interest, which differs spatially from the first region of interest, for the same end configuration from the at least one captured image, and the neural network is furthermore designed to, for the classification, additionally take into account a relative parameter, in particular a relative position, of the at least first region of interest and of the second region of interest and to determine a result associated with the classification, wherein a control signal for the at least one end configuration can be generated and output on the basis of the result of the classification taking into account the relative position.

### BRIEF DESCRIPTION OF THE FIGURES

Advantageous embodiments of the invention are explained below with reference to the accompanying figures. It shows:

FIG. 1 a schematic representation of one embodiment of the cable processing device,

FIG. 2 another schematic representation of the embodiment shown in FIG. 1,

FIG. 3 a schematic representation of the embodiment of the cable processing device suitable for a comprehensive influence on cable production,

FIG. 4 a first exemplary end configuration for which a plurality of areas of interest and their classification have been determined,

FIG. 5 a second exemplary end configuration for which a plurality of areas of interest and their classification were determined,

FIG. 6 a third exemplary end configuration for which a plurality of areas of interest and their classification were determined,

FIG. 7 a fourth exemplary end configuration for which a plurality of areas of interest and their classification were determined,

FIG. 8 a flow chart for the schematic representation of an exemplary sequence of the method.

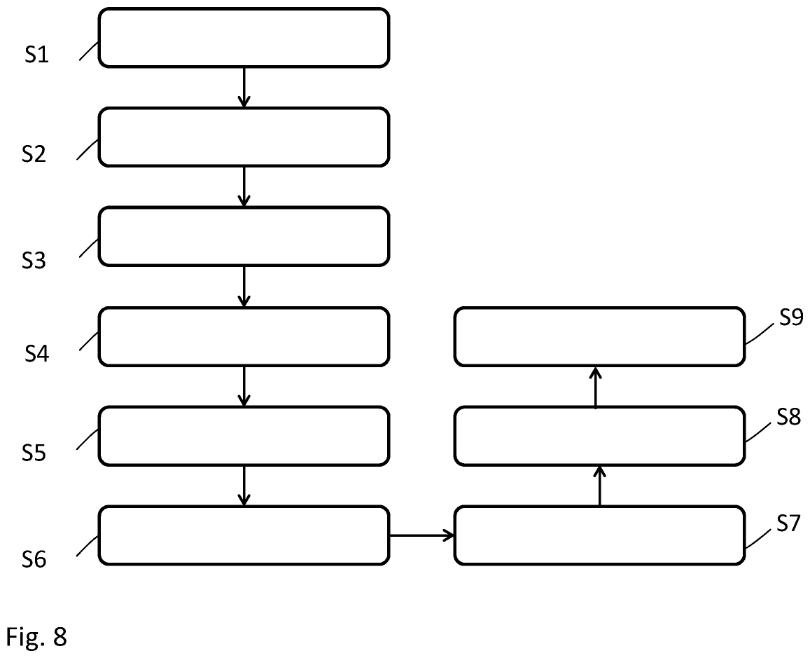

The figures are merely schematic representations and serve only to explain the invention. Elements which are identical or have the same effect are consistently marked with the same reference signs.

### DETAILED DESCRIPTION

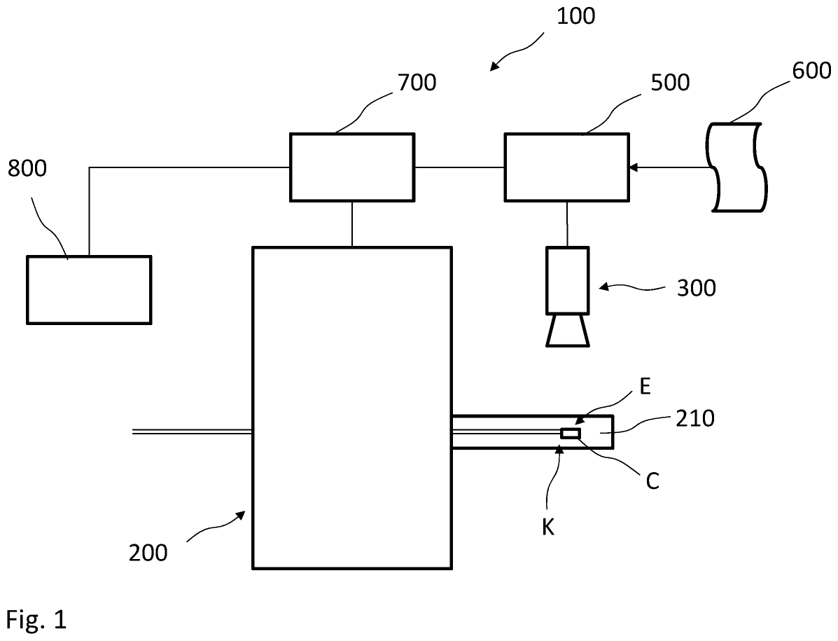

FIG. 1 shows a schematic view of a cable processing device 100. The cable processing device 100 comprises at least one cable processing unit 200, by means of which a cable or a cable section K is processed from an initial configuration into an end configuration E. The initial configuration denotes the initial configuration of the cable or cable section K prior to the processing. The end configuration refers to the state of the processed cable section K.

It is understood that a plurality of cable processing units 200 may be comprised by the cable processing device 100, each of which performs different processing steps on the cable, possibly also on different cable sections of the same cable.

The end configuration E may depend on the processing status of the cable or the cable section K and on the type of cable to be produced. In FIG. 1, the end configuration comprises the cable section K of the cable, which is designed as an end section, and a crimp sleeve C, which is schematically shown arranged on it. The end configuration can be recorded visually in the flow direction after the processing step, possibly also after exiting the cable processing unit 200, for example on a cable holding device 210.

This end configuration E is recorded by means of an image recording device 300. The recording area of the image recording device 300 for recording end configurations E is preferably 25 cm by 25 cm. If an end configuration E is arranged within the recording area, the image recording device 300 can record the end configurations E arranged therein in the recording area.

The image capturing device 300 is preferably configured as a digital camera and has a resolution of 1024×1024 pixels. With this configuration of recording area and resolution, it is ensured that the image is sufficiently well resolved to perform a reliable image evaluation. A lower resolution with the same recording area or a larger recording area with a lower resolution can adversely affect the result of the image analysis. It should be ensured that an area of interest comprises at least 20 pixels, preferably 50 or more pixels. However, a larger recording area and a larger resolution can be selected, but this can have disadvantages with regard to the speed of subsequent image processing.

Furthermore, the cable processing device 100 comprises an evaluation device 500. Image evaluation is performed by means of the evaluation device 500. The evaluation device 500 comprises a trained deep convolutional neural network which is designed to determine, in a first step, at least one region of interest of the at least one end configuration E from the at least one captured image and, in a second step, to determine a classification of the at least one determined region of interest with regard to the presence of a learned error pattern of the at least one end configuration E and a result assigned to the classification.

For this purpose, a machine-readable code 600 is loaded into a non-volatile memory of the evaluation device 500, which comprises the trained neural network. By means of the trained neural network, the evaluation device 500 can, by applying the trained neural network to the image, determine at least one region of interest of the end configuration E and classify this at least one region of interest.

Preferably, at least one region of interest is determined for each end configuration E determined by means of the image. Several areas of interest can also be determined for each end configuration E.

On the basis of the result of the classification for the determined areas of interest, the evaluation device 500 sends a control signal to a control device 700 comprised by the cable processing device 100. This control device 700 is designed to control or regulate the cable processing device 100. The evaluation device 500 can be provided separately from the control device 700. The evaluation device 500 can also be integrated in the control device 700.

Furthermore, the control device 700 is also operatively connected to an image output device 800. The control device 700 is designed to cause the information provided by the evaluation device 500 to be displayed on the image output device 800. Preferably, the areas of interest determined and the respective classification results are displayed on the image comprising the analyzed end configuration E.

The appropriately trained deep convolutional neural network is provided with raw data from the image recording device 300 that has not been preprocessed or otherwise prepared in the input layer, for example in the form 1024×1024×3. A tensor is therefore provided that has 1024×1024 pixels, which in turn can each have 3 RGB colors. The aim is that the captured images can be evaluated directly by the evaluation device 500 without further intermediate processing or preparation.

The output data may include, for example, the maximum number of areas of interest on the image, associated probability values for each of the areas of interest, the localization of the areas of interest by frames in the image, and the classification result, which distinguishes between defective and defect-free and may also include further information, e.g. the type of error pattern, as well as a further probability value for the presence of a specific error pattern. An output vector for the intended number of areas of interest that can be determined by means of the neural network is thus output, with the respective information on the respective areas of interest.

The deep convolutional neural network used is designed to first determine at least one region of interest per end configuration E of a cable section K, preferably several regions of interest per end configuration E of a cable section K, for a plurality of cable sections using the same deep convolutional neural network, and then to classify the determined regions of interest. This step-by-step procedure is carried out using the same network, which has been trained for this procedure.

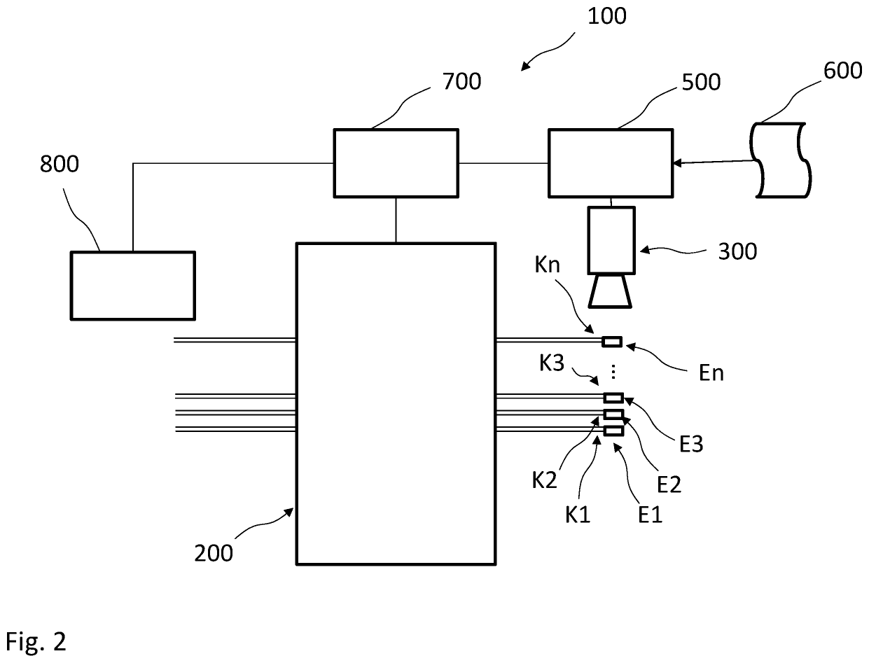

FIG. 2 illustrates the embodiment according to FIG. 1 with regard to the parallel cable processing capacity of the cable processing unit 200. The cable processing unit 200, as well as the cable processing device 100, is designed to process a plurality of cables, here n cables, in parallel. Preferably, 30 to 100 cables are processed simultaneously by the cable processing unit 200 and are each transferred from an initial configuration to an end configuration.

This poses the challenge of simultaneously providing a real-time check for a plurality of cables, e.g. 30 to 100 cables, to ensure that each individual cable has been processed without errors. The n end configurations are labeled E1, E2, E3 to En. The associated cable sections are labeled K1, K2, K3 to Kn.

It has been shown that the two-stage procedure, according to which at least one region of interest is determined for at least one end configuration and the determined at least one region of interest is then classified, is also particularly successful for a plurality of cable sections processed in parallel. A neural network trained with corresponding training data is a prerequisite.

Preferably, the neural network is designed such that it is capable of determining up to 100 regions of interest from 100 end configurations E1, E2, E3, . . . , En processed in parallel by means of the same cable processing unit 200. Furthermore, it is designed to provide the 100 areas of interest with probability values. If fewer than 100 end configurations are processed simultaneously, it determines a probability value for the difference between the number of detected end configurations and 100, which is below a predefined threshold value. The areas of interest with a probability below this threshold are not considered further and are not classified by the neural network.

This provides a neural network that is suitable for handling a flexible cable throughput through the cable processing unit up to a maximum number of cables or maximum number of end configurations E1, E2, E3, . . . , En in real time and for checking the manufacturing process. The maximum number of areas of interest that can be determined by the neural network can be selected in such a way that it corresponds to the maximum parallel processing capacity of the cable processing unit 200. For example, this can be selected to be higher by a factor of 2 to 5 than the maximum number of cables that can be processed in parallel, so that a plurality of areas of interest can be determined for each end configuration E1, E2, E3, . . . , En.

A plurality of areas of interest can also be determined for the plurality of end configurations E1, E2, E3, . . . , En, which allows a relational classification that takes into account relative parameters of two or more areas of interest to each other.

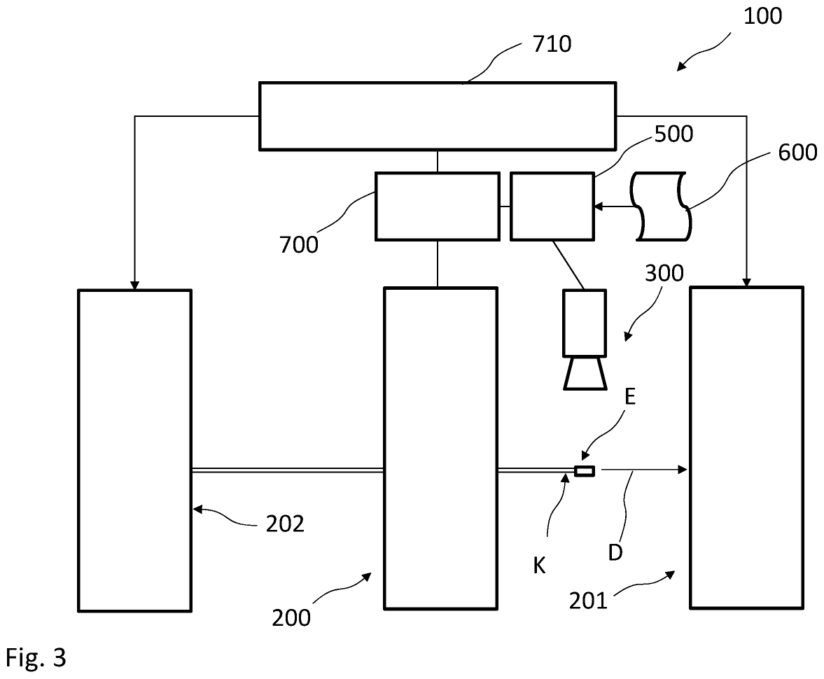

FIG. 3 shows a cable processing device 100, which comprises the cable processing unit 200 already shown in FIGS. 1 and 2, as well as a downstream cable processing unit 201 in the upstream flow direction of the cable processing unit, and an upstream cable pre-processing unit 202 in the flow direction of the cable processing unit 200. Furthermore, the cable processing device 100 comprises a higher-level control device 710, by means of which the cable pre-processing unit 202 and the downstream cable processing unit 201 can be influenced at least indirectly. The flow direction or material flow direction is labeled D.

While the control device 700 is designed to control or regulate the operation of the cable processing unit 200, the higher-level control device 710 is at least indirectly suitable for also influencing the operation of at least one cable pre-processing unit 202 upstream of the cable processing unit 200 in the flow direction D. Furthermore, the higher-level control device 710 is also at least indirectly suitable for influencing the operation of at least one downstream cable processing unit 201 downstream of the cable processing unit 200 in the flow direction D.

The cable pre-processing unit 202 and the downstream cable processing unit 201 can be units directly upstream or downstream of the cable processing unit 200. However, these can also be spaced further away from the cable processing unit 200.

The at least one cable pre-processing unit 202 and the at least one downstream cable processing unit 201 can each have their own control device for controlling and/or regulating their operation. Such a device is not shown in FIG. 3. It should be understood that it is not mandatory for a cable pre-processing unit 202 and a downstream cable processing unit 201 to be influenced. Rather, only an influence on the cable pre-processing device 202 or the downstream cable processing unit 201 can be provided.

Based on the captured image of the end configurations E with the image capture device 300, the evaluation device 500 is used to determine at least one region of interest of the end configurations E and to classify the at least one region of interest. If the classification of an area of interest leads to the result that an error pattern is present for a particular end configuration E and what type the error pattern is, the cable processing device 100, for example in the form of the control or regulation of the downstream cable processing unit 201, can be controlled and/or regulated in such a way that corrective processing of this end configuration E takes place for the erroneous end configuration E in a subsequent processing step by means of the downstream cable processing unit 201.

If, for example, a crimp sleeve is not crimped sufficiently tightly onto a stripped cable end in the cable processing unit 200, the position of the crimp sleeve is error-free, but it is also recognized as incorrectly crimped by means of the classification. This error pattern can be repaired. The error pattern for this end configuration can be corrected, for example, during housing application by applying the housing holding the crimp sleeve with a correspondingly increased contact pressure to the end configuration classified as repairably faulty. This can mitigate or compensate for the faulty crimping of the crimp sleeve so that the manufactured cable is ready for delivery and meets the quality standards.

This procedure can generally be used for all classified areas of interest that are known to have a repairable defect pattern that can be sufficiently corrected by downstream processing steps. This avoids rejects, increases production efficiency, and reduces the cost per cable.

Furthermore, the control device 700 is also designed to use the at least one determined area of interest and the associated classification result for a specific end configuration E to control and/or regulate the cable processing unit 200 in such a way that the determined error pattern is reduced or completely avoided for subsequent end configurations produced.

In the example cited with the crimp sleeve, for example, the contact pressure of the crimping press can be increased, in particular only for the position of the cable in the cable processing unit 200 for which the error pattern was detected. The determined area of interest and the associated classification can therefore be used to individually adjust the control variables of the cable processing unit 200 in such a way that a stable and optimized processing process for subsequent cable sections is achieved.

Furthermore, the cable processing device 100 of FIG. 3 can be designed to use the at least one determined area of interest and the associated classification result to influence the operation of a cable pre-processing unit 202 in such a way that a certain error pattern in the end configuration E of the cable section K, detected after processing with the cable processing unit 200, is reduced. This can also be done by means of the higher-level controller 710.

For example, the evaluation may show that the cable has not been stripped correctly and, for this reason, the crimp sleeve applied in the cable processing unit 200 is not positioned correctly. In this case, the error pattern is caused by the cable pre-processing unit 202, which performs the stripping step on the cable section. Consequently, this error pattern can be corrected if the operation of the cable pre-processing unit 202 is influenced in such a way that the stripping process is changed back towards a target result.

It is understood that these are merely exemplary explanations. Depending on the determined area of interest and its classification, this can be extended to any end configuration of the cable section. This applies accordingly to cable pre-processing unit 202 and downstream cable processing unit 201.

Such a procedure makes it possible that an image recording device for capturing end configurations and an image evaluation need not be carried out after each cable processing unit. Rather, a few image evaluations at a few cable processing units are sufficient, the results of which can be used to advantageously influence a plurality of production processes.

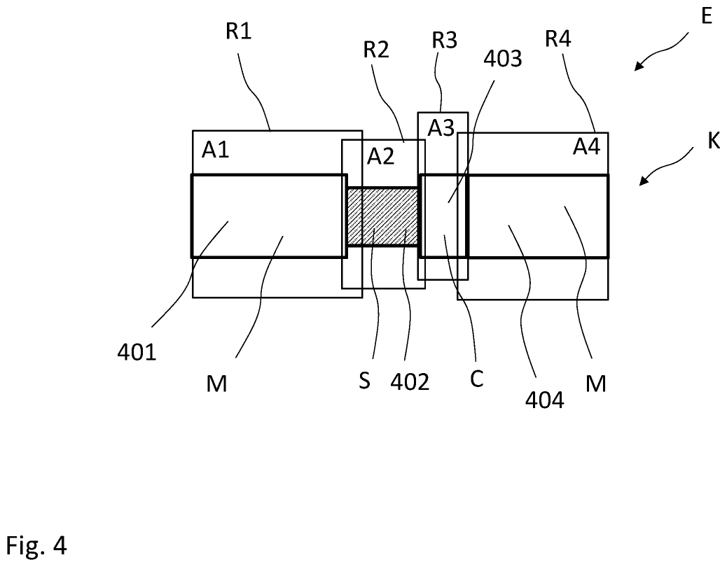

FIG. 4 shows a first exemplary end configuration E of a cable section K. The end configuration E comprises, from left to right, a sheath M of the cable, followed by a shield S of the cable, followed by a crimp sleeve C. The crimp sleeve C is followed by another sheath M of the cable.

Such an end configuration E can be captured by means of an image from the image processing device and is fed to the evaluation device. FIG. 4 now shows an exemplary result of an application of the neuronal network comprised by the evaluation device to the captured image of the end configuration E. This can be done accordingly if the image shows a plurality of end configurations E.

Four areas of interest for the present end configuration E are determined by means of the evaluation device. A first region of interest 401 is determined, which is assigned to the sheath M on the left-hand side in the figure. This has a probability above a threshold value, so that a box or frame R1 is used to mark it.

The neural network provides a position of the frame as an x-y coordinate in the image with an associated length specification in x and y direction. This applies to all frames in FIG. 4 and the subsequent figures accordingly.

Furthermore, the neural network is used to determine a second region of interest 402, which has a probability value that is above a threshold value. This second area of interest is assigned to the shielding S and is also marked with a frame R2 on the image.

Furthermore, the neural network is used to determine a third area of interest 403, which has a probability value that is above a threshold value. This third area of interest is assigned to the crimp sleeve and is also marked with a frame R3 on the image.

Furthermore, the neural network is used to determine a fourth area of interest 404, which has a probability value that is above a threshold value. This fourth area of interest is assigned to the right-sided sheath M in FIG. 4 and is also marked with a frame R4 on the image.

The frames R1, R2, R3, R4 are preferably assigned information A1, A1, A2, A3, which contain further information on the determined region of interest 401, 402, 403 and 404. For example, the information A1 to A4 may each comprise the probability with which an area of interest was determined. Furthermore, these indications A1, A1, A2, A3 preferably comprise the result of the classification as set out above.

In particular, it can be advantageous for faster comprehension by the staff to reproduce the result of the classification, e.g. OK vs. not OK, as color coding of the frames R1 to R4. For example, a traffic light system can be used, whereby a green frame stands for error-free and high probability of error-free, red for faulty and high probability of error, and yellow for classification results with insufficiently high probability, so that these require verification.

Furthermore, the information A1 to A4 can identify the error pattern in concrete terms, possibly only on user request, e.g. by hovering over the information using a control device, e.g. a mouse, so that the personnel can quickly determine and see which error pattern is present for an end configuration E.

Each of these determined areas can be classified in isolation, i.e. e.g. is the shielding braid processed in accordance with the process or not; is the crimp sleeve C processed in accordance with the process or not, in particular is this present in the crimped or uncrimped state or has the crimping been carried out without errors.

In the present end configuration E, a relational component is also taken into account in the classification, namely is the crimp sleeve C, in FIG. 4 the third area of interest 403, correctly positioned between the shielding braid S, in FIG. 4 the second area of interest 402, and the sheath M, in FIG. 4 the fourth area of interest 404. In other words, is the relative position of the third region of interest 403 to the second and fourth regions of interest 402 and 404 error-free.

It can thus be determined by means of the evaluation device for this end configuration E whether the crimp sleeve C is arranged in the correct position, namely between the shielding braid and the sheath, and whether the crimp sleeve has been crimped correctly or has not been crimped correctly or has not been crimped.

Such an exemplary evaluation can be carried out for a plurality of end configurations E that are processed in parallel and captured in the image.

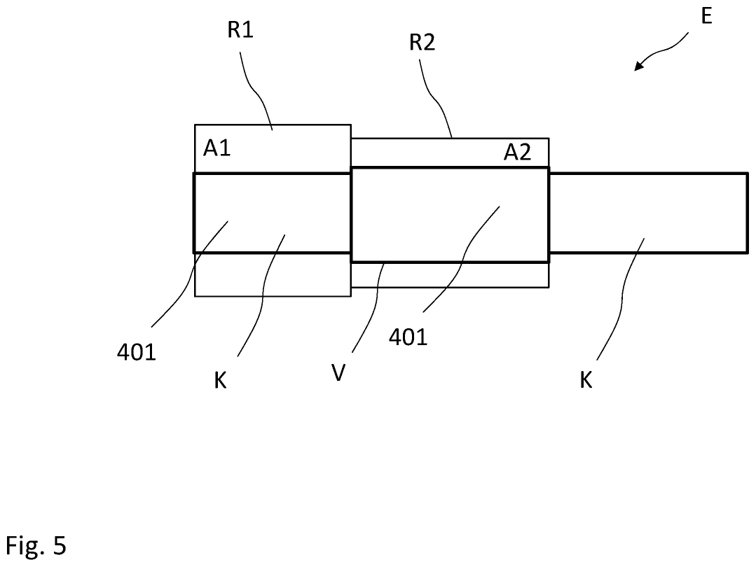

FIG. 5 shows a second exemplary end configuration E of a cable section. This end configuration E shows a cable K, determined as the first region of interest 401, and a connecting tube V, determined as the second region of interest 402. The determined regions of interest 401 and 402 are again each identified by means of a frame R1 and R2 respectively. The corresponding information A1 or A2, as explained for example in relation to FIG. 4, is arranged in the associated frame R1 or R2.

By means of the evaluation device, it can be determined from the image capturing the end configuration E that there is a first region of interest 401, which is classified as a cable, and a second region of interest 402, which is a connecting tube. By taking into account the relative position of the first and second regions of interest 401 and 402 for the classification, it can be determined whether, on the one hand, the connecting tube is arranged correctly with respect to the cable and, furthermore, whether the zero cut for the cable has been carried out correctly.

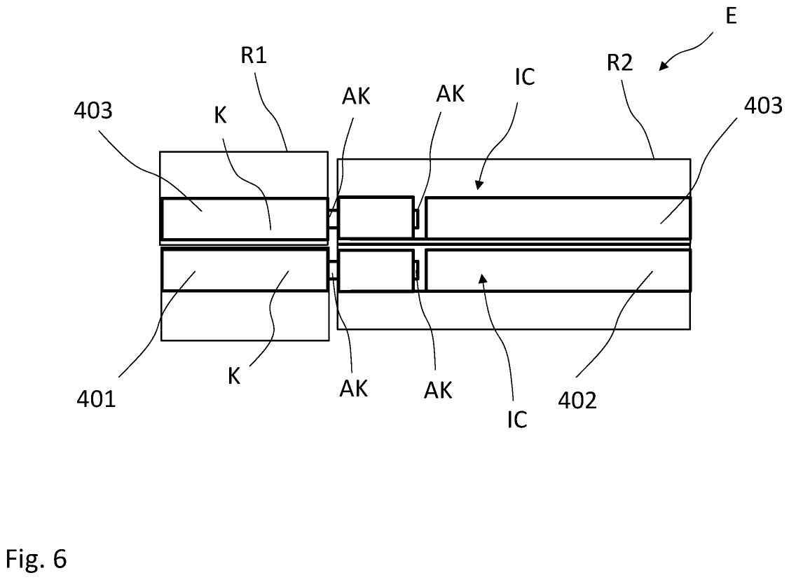

FIG. 6 shows a third exemplary end configuration E of a cable section. FIG. 6 shows two cables K and two internal contact crimps IC arranged at the stripped cable ends AK, each also referred to as a contact pin. The end configuration E captured in the image is fed back to the evaluation device.

Four areas of interest 401 to 404 are determined by the evaluation device. The first and third areas of interest 401 and 403 each correspond to the cable section before the stripped parts AK of the cable or the contact pins. The second and fourth areas of interest 402 and 403 each correspond to an internal contact crimp IC. Each internal contact crimp IC is guided and crimped with one of its sections over a contact pin.

By means of the evaluation device, it can be determined from the image capturing the end configuration E that there is a first and third area of interest 401, 403, which is classified as the cable section K adjacent to the contact pin AK, and a second and fourth area of interest 402 and 404, which are each an inner contact crimp IC. These are again identified by corresponding frames R1 to R4. For reasons of clarity, the information in the frames has been omitted for FIG. 6.

By taking into account the relative position of the first and second areas of interest 401 and 402 and the relative position of the third and fourth areas of interest 403 and 404 for the classification, it is possible to determine whether the inner contact crimp has been crimped onto the pin AK without errors in each case. In particular, the distance of the first and second regions of interest 401 and 402 can be used to determine whether the position of the inner contact crimp to the pin is error-free. The same applies to the third and fourth areas of interest 403 and 404.

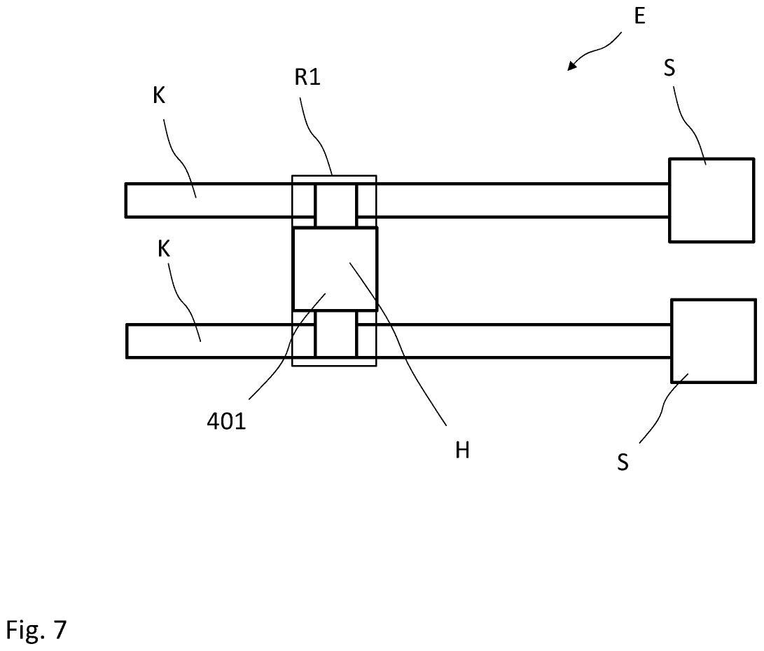

FIG. 7 shows a fourth exemplary end configuration E. This comprises two cables K, each of which is fitted with a connector S. These cables K are to be fitted with a cable holding device H, also referred to here as a separator.

The image of this end configuration E is again captured using a correspondingly prepared evaluation device. In a first step, the area of interest 401, which in this case corresponds to the holding device H, is again determined. By means of the subsequent classification of the determined area of interest 401, it can be determined whether the holding device H is attached to the cable sections K without errors.

It should be understood that the aforementioned examples for the application of the correspondingly formed neural network are not exhaustive, and a plurality of further application cases for cable processing are familiar to the person skilled in the art. In particular, one embodiment of the invention can also be used for checking the marking of cables, in particular laser markings on the cable sheath, for the correct attachment of labels and tags to the cable, in particular with regard to conformity with the laser marking, the attachment of grommets and their holders, the attachment of couplings for sensor lines, the arrangement of protective caps on connectors, of ferrules on optical conductor end pieces, the arrangement of a silicone insulating tube on the cable, the attachment of outer conductors, etc.

FIG. 7 shows a schematic process sequence as a flowchart for one embodiment of the process for operating a cable processing device.

In a process step S1, at least one cable section, preferably a plurality of cable sections, is processed from an initial configuration to an end configuration. This can be any processing step. However, with regard to the subsequent image capture of the at least one end configuration, the processing step should influence the visual appearance of the cable end piece, as the subsequent evaluation is image-based.

In a process step S2, the at least one end configuration arranged in the recording area, preferably the plurality of end configurations, is recorded by means of an image recording device and the image is fed to an evaluation device for evaluating the end configuration recorded on the image. In the following, it is assumed—without limiting the applicability for processing only a single end configuration—that a plurality of end configurations is captured. The image acquisition can be initiated by the evaluation device or a control device.

In a process step S3, the neural network is used to check whether all the end configurations depicted have been fully captured in the image or whether end configurations that have been incompletely captured are depicted in the image. If end configurations are incompletely captured, an error signal is output, possibly only when the classification for the fully captured end configurations is available, from which an incomplete image capture becomes apparent. The reason for the incomplete capture can then be eliminated.

For the fully captured end configurations, the next process step S4 uses the neural network to determine a plurality of areas of interest from the image, whereby each end configuration can also have a plurality of areas of interest. The neural network is accordingly designed to determine the desired plurality of regions of interest.

In a next method step S5, a classification is carried out for the determined areas of interest with regard to the presence of a error pattern and a result corresponding to the classification is determined.

In a next method step S6, a control signal is generated and output, which is dependent on the at least one determined area of interest and/or dependent on the determined result of the classification of the at least one end configuration. Preferably, the control signal is output to a control device.

In a method step S7, the information determined by the evaluation device from the captured image is output graphically on the basis of the control signal. The plurality of detected areas of interest and an associated classification result are output on a monitor.

Furthermore, in a process step S8, the control device checks whether it is appropriate to influence the cable processing unit, a cable pre-processing unit, or a downstream cable processing unit, or to reject a cable from production on the basis of the control signal.

If necessary, a control intervention for a corresponding control variable of the production takes place in a process step S9, which contributes to avoiding an error pattern for an end configuration, corrects the error pattern for a specific end configuration or causes a cable or cable section to be rejected from production.

Since the devices and methods described in detail above are examples of embodiments, they can usually be modified to a wide extent by a person skilled in the art without departing from the scope of the invention. In particular, the mechanical arrangements and the proportions of the individual elements to one another are merely exemplary.

### REFERENCE LIST

100 cable processing device
200 cable processing unit
201 downstream cable processing unit
202 cable pre-processing unit
210 cable holder
300 image recording device
401 area of interest, first
402 area of interest, second
403 area of interest, third
404 area of interest, fourth
500 evaluation device
600 machine-readable program code
700 control device
710 cable production control
800 image output device
K, K1, K2, K3, Kn cable sections
E, E1, E2, E3, En end configurations
C crimp sleeve
IC internal contact crimp
S plug
M sheath
H cable retention device
R1, R2, R3, R4 frames surrounding a determined area of interest
A1, A2, A3, A4 classification information
S1 Simultaneous processing of a plurality of cable sections each from an initial configuration to a end configuration by means of a cable processing unit.
S2 Detection of the plurality of end configurations arranged in the recording area
S3 Check for complete detection of end configurations
S4 Determination of a plurality of areas of interest
S5 Performing the classification for the determined areas of interest
S6 Generating and outputting a control signal based on the determined areas of interest and their classification
S7 Graphical output of the results of the evaluation device
S8 Check for control variable intervention for cable processing unit, cable pre-processing unit, downstream cable processing unit and rejection
S9 Execution of the measure determined from the test

1. Method of operating a cable processing device, the method comprising:
processing at least one cable section comprising a cable end, by a cable processing unit from an initial configuration to an end configuration;
capturing at least one image of the end configuration by an image capturing device;
applying a trained neural network to the at least one image, the trained neural network being designed to determine at least one region of interest of the end configuration from the at least one image in a first step, and the same neural network being designed to, in a second step, perform a classification of the at least one determined region of interest with regard to the presence of at least one learned error pattern of the end configuration and to determine a result associated with the classification; and
generating and outputting a control signal that is at least one of: a function of the at least one determined region of interest or a function of the determined result of the classification of the end configuration.

2. Method according to claim 1, wherein an image showing two end configurations is captured by the image capture device, wherein the trained neural network is designed to recognize at least one region of interest for each of the two end configurations, and to determine a result assigned to the classification for the respective end configuration, wherein the trained neural network is applied to the image showing the two end configurations, wherein a control signal for the two end configurations is generated and output on a basis of at least one of: the determined at least one region of interest, or the result assigned to the classification for the respective end configuration.

3. Method according to claim 1, wherein the trained neural network is adapted to generate at least a first region of interest for the end configuration and at least a second region of interest for the same end configuration, the second region of interest differing spatially from the first region of interest from the at least one image, and the neural network is furthermore designed to additionally determine a relative position for the classification of the first region of interest and of the second region of interest and to determine a result associated with the classification, and wherein the trained neural network is applied to the at least one image, wherein a control signal for the end configuration is generated and output on a basis of the result of the classification taking into account the relative position.

4. Method according to claim 1, wherein capturing the at least one image of the end configuration is performed by a digital image recording device, wherein the at least one region of interest is represented by at least 20 pixels.

5. Method according to claim 1, wherein the trained neural network is adapted to determine a complete image capture of the end configuration, wherein the trained neural network is applied to the at least one image, wherein in case of the determined incomplete capture of the end configuration a control signal is generated and output, which causes a notification of an image capture error.

6. Method according to claim 1, wherein by the control signal a graphical display of the at least one determined region of interest in the image showing the end configuration as a colored outline of the at least one determined region of interest, is initiated on an image output device.

7. Method according to claim 1, wherein a graphical display of the result of the classification for the end configuration in the image showing the at least one end configuration is initiated on an image output device by the control signal.

8. Method according to claim 7, wherein an error pattern associated with the result of the classification is reproduced by the graphic display in a form of an error pattern designation.

9. Method according to claim 8, wherein a probability for the error pattern is reproduced by the graphical display.

10. Method according to claim 1, wherein the operation of the cable processing unit is influenced by the control signal in such a way that an end configuration of a second cable section to be subsequently processed in time is approximated to a desired end configuration by the cable processing unit.

11. Method according to claim 1, wherein, by the control signal, downstream cable processing performed by a downstream cable processing unit downstream of the cable processing unit in terms of process sequence of at least one classified end configuration is influenced depending on the result of the classification of the end configuration.

12. Method according to claim 1, wherein the control signal is used to cause a cable section with an end configuration with an error pattern to be rejected from a production process, wherein a rejection takes place if the result of the classification for the end configuration corresponds to a predetermined error pattern with a probability threshold above a predetermined threshold and cannot be corrected by a downstream cable processing unit.

13. Cable processing device comprising:
at least one cable processing unit configured to pick up at least one cable section comprising cable end, and to process the at least one cable section in such a way that the at least one cable section is transferred from an initial configuration to an end configuration,
an image recording device configured to record at least one image of the end configuration, and
an evaluation device and a control device for at least one of controlling or regulating the cable processing device, wherein the evaluation device is operatively connected to the image recording device and the control device, and wherein machine-readable program code is loaded into at least one of the evaluation device or into the control device, which, when executed, performs an operation, the operation comprising:
applying a trained neural network to the at least one image, the trained neural network being designed to determine at least one region of interest of the end configuration from the at least one image in a first step, and the same neural network being designed to, in a second step, perform a classification of the at least one determined region of interest with regard to the presence of at least one learned error pattern of the end configuration and to determine a result associated with the classification, and
generating and outputting a control signal that is at least one of: a function of the at least one determined region of interest or a function of the determined result of the classification of the end configuration.

14. Cable processing device of claim 13, wherein the image recording device is configured to capture an image showing two end configurations, wherein the trained neural network is designed to recognize at least one region of interest for each of the two end configurations, and to determine a result assigned to the classification for the respective end configuration, wherein the trained neural network is applied to the image showing the two end configurations, wherein a control signal for the two end configurations is generated and output on a basis of at least one of: the determined at least one region of interest, or the result assigned to the classification for the respective end configuration.

15. Cable processing device of claim 13, wherein the trained neural network is adapted to generate at least a first region of interest for the end configuration and at least a second region of interest for the same end configuration, the second region of interest differing spatially from the first region of interest from the at least one image, and the neural network is furthermore designed to additionally determine a relative position for the classification of the first region of interest and of the second region of interest and to determine a result associated with the classification, and wherein the trained neural network is applied to the at least one image, wherein a control signal for the end configuration is generated and output on a basis of the result of the classification taking into account the relative position.

16. Cable processing device of claim 13, wherein capturing the image of the end configuration is performed by a digital image recording device, wherein the at least one region of interest is represented by at least 20 pixels.

17. A control or evaluation device for at least one of controlling or regulating a cable processing device, wherein the control or evaluation device is operatively connected to an image recording device, the control or evaluation device containing machine-readable program code which comprises control instructions which, when executed by the control or evaluation device performs an operation, the operation comprising:
applying a trained neural network to at least one image of an end configuration of a cable end which has been processed from an initial configuration to the end configuration, the trained neural network being designed to determine at least one region of interest of the end configuration from the at least one image in a first step, and the same neural network being designed to, in a second step, perform a classification of the at least one determined region of interest with regard to the presence of at least one learned error pattern of the end configuration and to determine a result associated with the classification, and
generating and outputting a control signal that is at least one of: a function of the at least one determined region of interest or a function of the determined result of the classification of the end configuration.

18. The control or evaluation device of claim 17, wherein the image recording device is configured to provide to the control or evaluation device an image showing two end configurations, wherein the trained neural network is designed to recognize at least one region of interest for each of the two end configurations, and to determine a result assigned to the classification for the respective end configuration, wherein the trained neural network is applied to the image showing the two end configurations, wherein a control signal for the two end configurations is generated and output on a basis of at least one of: the determined at least one region of interest, or the result assigned to the classification for the respective end configuration.

19. The control or evaluation device of claim 17, wherein the trained neural network is adapted to generate at least a first region of interest for the end configuration and at least a second region of interest for the same end configuration, the second region of interest differing spatially from the first region of interest from the at least one image, and the neural network is furthermore designed to additionally determine a relative position for the classification of the first region of interest and of the second region of interest and to determine a result associated with the classification, and wherein the trained neural network is applied to the at least one image, wherein a control signal for the end configuration is generated and output on a basis of the result of the classification taking into account the relative position.

20. The control or evaluation device of claim 17, wherein capturing the image of the end configuration is performed by a digital image recording device, wherein the at least one region of interest is represented by at least 20 pixels.
